(19) United States
(12) Patent Application Publication
(10) Pub. No.: US 2025/0008583 A1
(43) Pub. Date: Jan. 2, 2025

(54) METHOD FOR ADJUSTING DATA TRANSMISSION SEQUENCE AND ELECTRONIC DEVICE FOR PERFORMING SAME

(71) Applicant: Samsung Electronics Co., Ltd., Suwon-si (KR)

(72) Inventors: Junhwan AN, Suwon-si (KR); Beomjip KIM, Suwon-si (KR)

(21) Appl. No.: 18/882,051

(22) Filed: Sep. 11, 2024

Related U.S. Application Data
(63) Continuation of application No. PCT/KR2023/005094, filed on Apr. 14, 2023.

(30) Foreign Application Priority Data
May 13, 2022 (KR) 10-2022-0058981
Jul. 28, 2022 (KR) 10-2022-0094179

(51) Int. Cl. H04W 76/14; H04W 8/22

(52) U.S. Cl. CPC H04W 76/14; H04W 8/22

(57) ABSTRACT

A method for adjusting a data transmission sequence and an electronic device for performing same are provided. The electronic device includes memory storing one or more computer programs, and one or more processors communicatively coupled to the memory, wherein the one or more computer programs include computer-executable instructions that, when executed by the one or more processors individually or collectively, cause the electronic device to search for external electronic devices located near the electronic device, receive user inputs for selecting external electronic devices to which data of the electronic device is to be transmitted from among found external electronic devices, adjust a data transmission order corresponding to an order in which the selected external electronic devices are selected by the user inputs, based on at least one of the communication connection characteristics of the selected external electronic devices, a size of the data, or account information of the selected external electronic devices, and transmit the data to the selected external electronic devices according to the adjusted data transmission order.

### CROSS-REFERENCE TO RELATED APPLICATION(S)

This application is a continuation application, claiming priority under 35 § 365 (c), of an International application No. PCT/KR2023/005094, filed on Apr. 14, 2023, which is based on and claims the benefit of a Korean patent application number 10-2022-0058981, filed on May 13, 2022, in the Korean Intellectual Property Office, and of a Korean patent application number 10-2022-0094179, filed on Jul. 28, 2022, in the Korean Intellectual Property Office, the disclosure of each of which is incorporated by reference herein in its entirety.

### BACKGROUND

### 1. Field

The disclosure relates to technology for adjusting a data transmission order between electronic devices.

### 2. Description of Related Art

An electronic device may search for nearby electronic devices using short-range wireless communication. The electronic device may be connected to and communicate with the nearby electronic devices through various wireless connection methods. For example, the electronic device may communicate with the nearby electronic devices using wireless connection methods, such as wireless fidelity direct (Wi-Fi direct), wireless fidelity aware (Wi-Fi aware), neighborhood aware networking (NAN) communication, local area network (LAN) communication, Bluetooth™ communication, or thread communication.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method for adjusting data transmission sequence and electronic device for performing same.

Additional aspects will be set forth in part in the description which follows and, in part, will be apparent from the description, or may be learned by practice of the presented embodiments.

In accordance with an aspect of the disclosure, an electronic device is provided. The electronic device includes memory storing one or more computer programs, and one or more processors communicatively coupled to the memory, wherein the one or more computer programs include computer-executable instructions that, when executed by the one or more processors individually or collectively, cause the electronic device to search for external electronic devices located near the electronic device, receive user inputs for selecting external electronic devices to which data of the electronic device is to be transmitted from among found external electronic devices, adjust a data transmission order corresponding to an order in which the selected external electronic devices are selected by the user inputs, based on at least one of communication connection characteristics of the selected external electronic devices, a size of the data, or account information of the selected external electronic devices, and transmit the data to the selected external electronic devices according to the adjusted data transmission order.

In accordance with another aspect of the disclosure, a method of adjusting a data transmission order from an electronic device to external electronic devices is provided. The method includes searching for external electronic devices located near the electronic device, receiving user inputs for selecting an external electronic device to which data of the electronic device is to be transmitted from among found external electronic devices, adjusting a data transmission order corresponding to an order in which the selected external electronic devices are selected by the user inputs, based on at least one of communication connection characteristics of the selected external electronic devices, a size of the data, or account information of the selected external electronic devices, and transmitting the data to the selected external electronic devices according to the adjusted data transmission order.

In accordance with another aspect of the disclosure, one or more non-transitory computer-readable storage media storing computer-executable instructions that, when executed by one or more processors individually or collectively, cause an electronic device to perform operations of adjusting a data transmission order from the electronic device to external electronic devices are provided. The operations include searching for external electronic devices located near the electronic device, receiving user inputs for selecting an external electronic device to which data of the electronic device is to be transmitted from among found external electronic devices, adjusting a data transmission order corresponding to an order in which the selected external electronic devices are selected by the user inputs, based on at least one of communication connection characteristics of the selected external electronic devices, a size of the data, or account information of the selected external electronic devices, and transmitting the data to the selected external electronic devices according to the adjusted data transmission order.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment, according to an embodiment of the disclosure;

FIG. 2 is a diagram illustrating an overview of a method of adjusting a data transmission order and an electronic device for performing the same, according to an embodiment of the disclosure;

FIG. 3 is a diagram illustrating an electronic device changes a data transmission order according to a wireless connection method of external electronic devices, according to an embodiment of the disclosure;

FIG. 4 is a flowchart of a method of adjusting a data transmission order according to an embodiment of the disclosure;

FIG. 5 is a flowchart of an electronic device changes a data transmission order of external electronic devices, according to an embodiment of the disclosure; and

FIG. 6 is a block diagram illustrating an electronic device according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

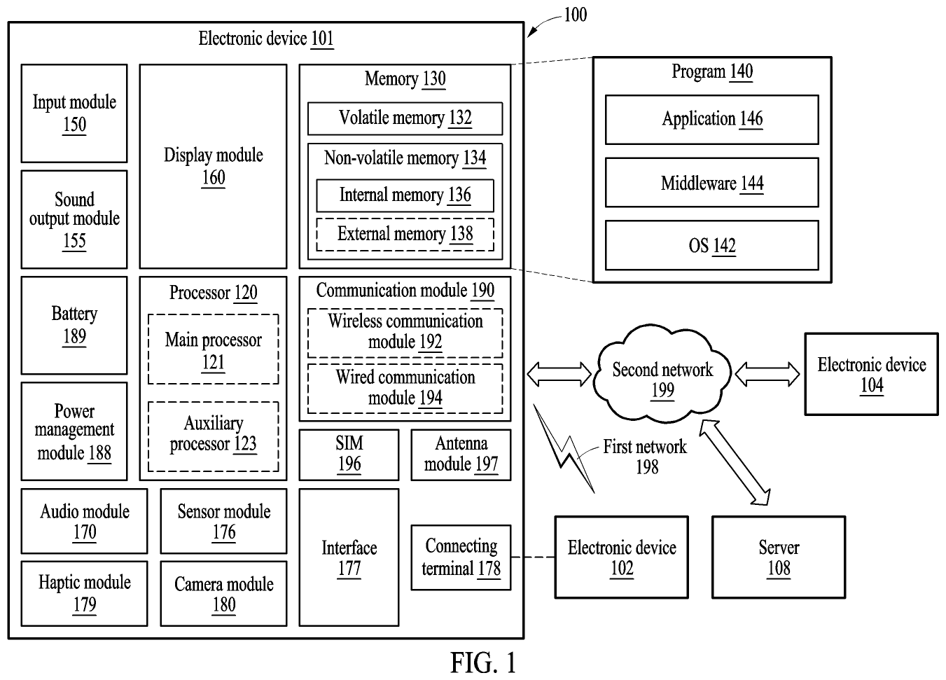

FIG. 1 is a block diagram illustrating an electronic device in a network environment according to an embodiment of the disclosure.

Referring to FIG. 1, an electronic device 101 in a network environment 100 may communicate with an external electronic device 102 via a first network 198 (e.g., a short-range wireless communication network), or communicate with at least one of an external electronic device 104 or a server 108 via a second network 199 (e.g., a long-range wireless communication network). According to an embodiment of the disclosure, the electronic device 101 may communicate with the external electronic device 104 via the server 108. According to an embodiment of the disclosure, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments of the disclosure, at least one of the components (e.g., the connecting terminal 178) may be omitted from the electronic device 101, or one or more other components may be added to the electronic device 101. In some embodiments of the disclosure, some of the components (e.g., the sensor module 176, the camera module 180, or the antenna module 197) may be integrated as a single component (e.g., the display module 160).

The processor 120 may execute, for example, software (e.g., a program 140) to control at least one other component (e.g., a hardware or software component) of the electronic device 101 connected to the processor 120 and may perform various data processing or computation. According to an embodiment of the disclosure, as at least a part of data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment of the disclosure, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with the main processor 121. For example, when the electronic device 101 includes the main processor 121 and the auxiliary processor 123, the auxiliary processor 123 may be adapted to consume less power than the main processor 121 or to be specific to a specified function. The auxiliary processor 123 may be implemented separately from the main processor 121 or as a part of the main processor 121.

The auxiliary processor 123 may control at least some of functions or states related to at least one (e.g., the display module 160, the sensor module 176, or the communication module 190) of the components of the electronic device 101, instead of the main processor 121 while the main processor 121 is in an inactive (e.g., a sleep) state or along with the main processor 121 while the main processor 121 is in an active state (e.g., executing an application). According to an embodiment of the disclosure, the auxiliary processor 123 (e.g., an ISP or a CP) may be implemented as a portion of another component (e.g., the camera module 180 or the communication module 190) that is functionally related to the assistance processor 123. According to an embodiment of the disclosure, the auxiliary processor 123 (e.g., an NPU) may include a hardware structure specialized for artificial intelligence model processing. An artificial intelligence model may be generated through machine learning. Such learning may be performed, for example, by the electronic device 101 in which an artificial intelligence model is executed, or via a separate server (e.g., the server 108). Learning algorithms may include, but are not limited to, e.g., supervised learning, unsupervised learning, semi-supervised learning, or reinforcement learning. The AI model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more thereof, but is not limited thereto. The artificial intelligence model may additionally or alternatively include a software structure other than the hardware structure.

The memory 130 may store various pieces of data used by at least one component (e.g., the processor 120 or the sensor module 176) of the electronic device 101. The various pieces of data may include, for example, software (e.g., the program 140) and input data or output data for a command related thereto. The memory 130 may include the volatile memory 132 or the non-volatile memory 134.

The program 140 may be stored as software in the memory 130 and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output a sound signal to the outside of the electronic device 101. The sound output module 155 may include, for example, a speaker or a receiver. The speaker may be used for general purposes, such as playing multimedia or playing a record. The receiver may be used to receive an incoming call. According to an embodiment of the disclosure, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, the hologram device, and the projector. According to an embodiment of the disclosure, the display module 160 may include a touch sensor adapted to detect a touch, or a pressure sensor adapted to measure the intensity of force incurred by the touch.

The audio module 170 may convert a sound into an electrical signal or vice versa. According to an embodiment of the disclosure, the audio module 170 may obtain the sound via the input module 150 or output the sound via the sound output module 155 or an external electronic device (e.g., the external electronic device 102, such as a speaker or headphones) directly or wirelessly connected to the electronic device 101.

The sensor module 176 may detect an operational state (e.g., power or temperature) of the electronic device 101 or an environmental state (e.g., a state of a user) external to the electronic device 101 and may generate an electrical signal or data value corresponding to the detected state. According to an embodiment of the disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., by wire) or wirelessly. According to an embodiment of the disclosure, the interface 177 may include, for example, a high-definition multimedia interface (HDMI), a universal serial bus (USB) interface, a secure digital (SD) card interface, or an audio interface.

The connecting terminal 178 may include a connector via which the electronic device 101 may be physically connected to an external electronic device (e.g., the external electronic device 102). According to an embodiment of the disclosure, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or an electrical stimulus which may be recognized by a user via their tactile sensation or kinesthetic sensation. According to an embodiment of the disclosure, the haptic module 179 may include, for example, a motor, a piezoelectric element, or an electric stimulator.

The camera module 180 may capture a still image and moving images. According to an embodiment of the disclosure, the camera module 180 may include one or more lenses, image sensors, ISPs, or flashes.

The power management module 188 may manage power supplied to the electronic device 101. According to an embodiment of the disclosure, the power management module 188 may be implemented as, for example, at least a part of a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more CPs that are operable independently of the processor 120 (e.g., an AP) and that support direct (e.g., wired) communication or wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via the first network 198 (e.g., a short-range communication network, such as Bluetooth™, wireless fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., a LAN or a wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network after a fourth generation (4G) network, and next-generation communication technology, for example, new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., a millimeter wave (mmWave) band) to achieve, e.g., a high data transmission rate. The wireless communication module 192 may support various technologies for securing performance on a high-frequency band, such as, e.g., beamforming, massive multiple-input and multiple-output (MIMO), full dimensional MIMO (FD-MIMO), an array antenna, analog beam-forming, or a large scale antenna. The wireless communication module 192 may support various requirements specified in the electronic device 101, an external electronic device (e.g., the external electronic device 104), or a network system (e.g., the second network 199). According to an embodiment of the disclosure, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment of the disclosure, the antenna module 197 may include an antenna including a radiating element including a conductive material or a conductive pattern formed in or on a substrate (e.g., a printed circuit board (PCB)). According to an embodiment of the disclosure, the antenna module 197 may include a plurality of antennas (e.g., array antennas). In such a case, at least one antenna appropriate for a communication scheme used in a communication network, such as the first network 198 or the second network 199, may be selected by, for example, the communication module 190 from the plurality of antennas. The signal or power may be transmitted or received between the communication module 190 and the external electronic device via the at least one selected antenna. According to one embodiment of the disclosure, another component (e.g., a radio frequency integrated circuit (RFIC)) other than the radiating element may be additionally formed as a part of the antenna module 197.

According to embodiments of the disclosure, the antenna module 197 may form a mmWave antenna module. According to an example embodiment of the disclosure, the mmWave antenna module may include a PCB, an RFIC disposed on a first surface (e.g., a bottom surface) of the PCB or adjacent to the first surface and capable of supporting a designated high-frequency band (e.g., the mmWave band), and a plurality of antennas (e.g., array antennas) disposed on a second surface (e.g., a top or a side surface) of the PCB, or adjacent to the second surface and capable of transmitting or receiving signals in the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an example embodiment of the disclosure, commands or data may be transmitted or received between the electronic device 101 and the external electronic device 104 via the server 108 coupled with the second network 199. Each of the external electronic devices 102 or 104 may be a device of the same type as or a different type from the electronic device 101. According to an embodiment of the disclosure, all or some of operations to be executed by the electronic device 101 may be executed by one or more external electronic devices (e.g., the external electronic devices 102 or 104, or the server 108). For example, if the electronic device 101 needs to perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and may transfer an outcome of the performing to the electronic device 101. The electronic device 101 may provide the outcome, with or without further processing of the outcome, as at least part of a reply to the request. To this end, cloud computing, distributed computing, mobile edge computing (MEC), or client-server computing technology may be used, for example. The electronic device 101 may provide ultra-low-latency services using, e.g., distributed computing or mobile edge computing. In an embodiment of the disclosure, the external electronic device 104 may include an Internet-of-things (IoT) device. The server 108 may be an intelligent server using machine learning and/or a neural network. According to an embodiment of the disclosure, the external electronic device 104 or the server 108 may be included in the second network 199. The electronic device 101 may be applied to intelligent services (e.g., a smart home, a smart city, a smart car, or healthcare) based on 5G communication technology or IoT-related technology.

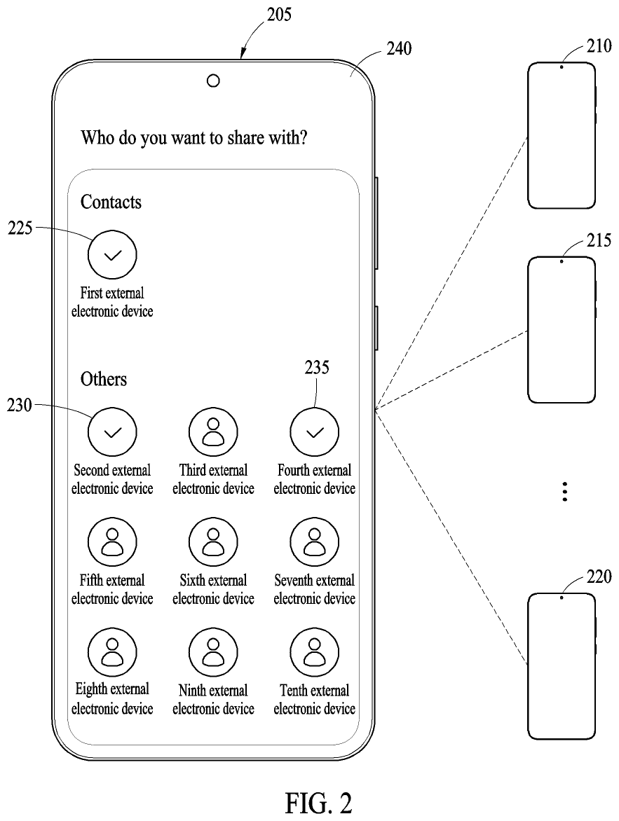

FIG. 2 is a diagram illustrating an overview of a method of adjusting a data transmission order and an electronic device for performing the same according to an embodiment of the disclosure.

Referring to FIG. 2, an electronic device 205 (e.g., the electronic device 101 of FIG. 1) to transmit data and external electronic devices 210, 215, and 220 capable of receiving data from the electronic device 205 are shown. In an embodiment of the disclosure, the electronic device 205 may search for the external electronic devices 210, 215, and 220 around the electronic device 205 using short-range wireless communication (e.g., Bluetooth™ low energy (BLE) communication). The electronic device 205 may transmit data of the electronic device 205 by communicating with the found external electronic devices 210, 215, and 220.

The electronic device 205 may display the found external electronic devices 210, 215, and 220 on a display 240 (e.g., the display of the display module 160 of FIG. 1) of the electronic device 205. For example, the found external electronic devices 210, 215, and 220 are displayed on the display 240 in a form of an icon as shown in FIG. 2. A user of the electronic device 205 may view the display 240 of the electronic device 205 and select at least one external electronic device, to which the data of the electronic device 205 is to be transmitted, from among the found external electronic devices 210, 215, and 220. For example, the user may select external electronic devices to which the data is to be transmitted by touching an icon (e.g., an icon 225, an icon 230, or an icon 235) of an external electronic device to which the data is to be transmitted among icons corresponding to external electronic devices displayed on the display 240.

The electronic device 205 may receive user inputs (e.g., touch inputs for the icon 225, the icon 230, or the icon 235) for selecting an external electronic device to receive the data of the electronic device 205. The electronic device 205 may perform authentication with the external electronic devices selected by the user inputs and transmit the data of the electronic device 205 through wireless connection with the selected external electronic devices.

When the user selects external electronic devices to receive data through user inputs, the electronic device 205 may transmit the data to the external electronic devices in an order in which each of the external electronic devices is selected. In an embodiment of the disclosure, various wireless connection methods may be used for communication between the electronic device 205 and external electronic devices. The wireless connection methods used by the selected external electronic devices may be the same or different for each of the external electronic devices. For example, when transmitting data in the order selected by the user, the wireless connection method used by an external electronic device (e.g., an external electronic device corresponding to the icon 225) currently transmitting data and the wireless connection method used by an external electronic device (e.g., an external electronic device corresponding to the icon 230) in a next order may be different from each other. For example, the external electronic device (e.g., an external electronic device corresponding to the icon 225) currently transmitting data may use a wireless fidelity aware (Wi-Fi Aware) wireless connection method, and the external electronic device (e.g., the external electronic device corresponding to the icon 230) in the next order may use a wireless fidelity direct (Wi-Fi Direct) wireless connection method. However, this is only an example, and external electronic devices may use various wireless connection methods.

When a wireless connection method used by the external electronic device (e.g., the external electronic device corresponding to the icon 225) currently transmitting data is different from a wireless connection method used by the external electronic device (e.g., the external electronic device corresponding to the icon 230) in the next order, it may take time to switch the wireless connection method when the electronic device 205 transmits data to the external electronic device (e.g., the external electronic device corresponding to the icon 230) in the next order. Due to the time taken to switch the wireless connection method, transmitting data may take more time.

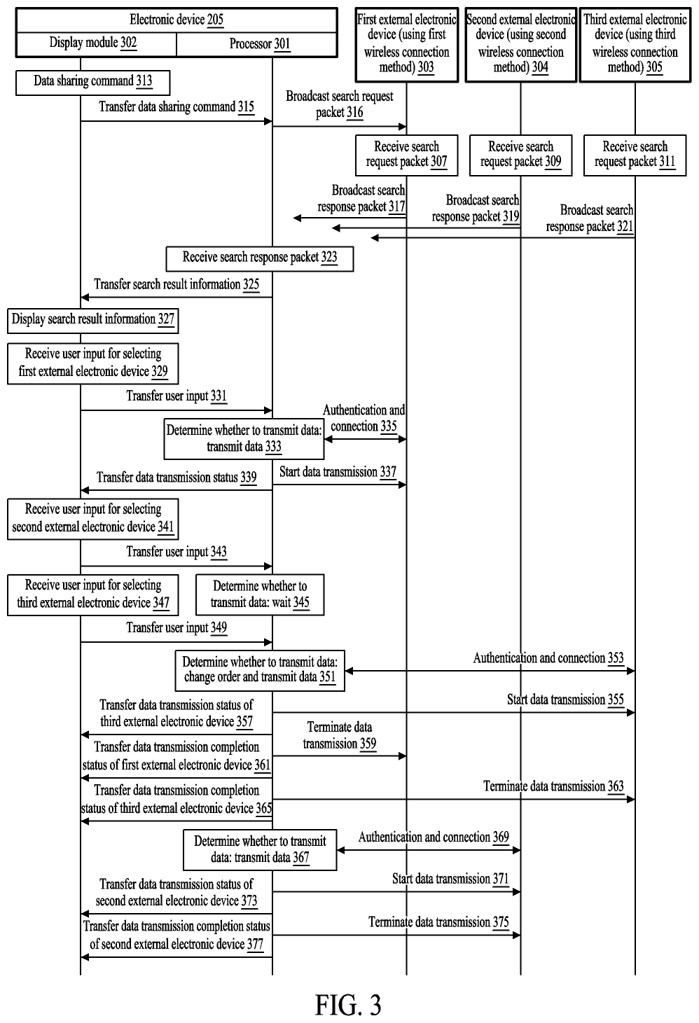

According to an embodiment of the disclosure, the electronic device 205 may search for external electronic devices near the electronic device 205 and select an external electronic device to transmit data based on a user input. The electronic device 205 may reduce data transmission time by adjusting a data transmission order corresponding to the order in which the external electronic device is selected by user inputs. The electronic device 205 may reduce a total data transmission time by adjusting the data transmission order corresponding to the order in which the external electronic device is selected by the user inputs. For example, the electronic device 205 may adjust the data transmission order corresponding to the order in which the external electronic device is selected by the user inputs, based on at least one of communication connection characteristics of the selected external electronic devices, a size of the data, and account information of the selected external electronic devices. An embodiment in which the data transmission order is adjusted is described with reference to FIG. 3.

FIG. 3 is a diagram illustrating an electronic device changes a data transmission order according to a wireless connection method of external electronic devices according to an embodiment of the disclosure.

Referring to FIG. 3, the electronic device 205 (e.g., the electronic device 101 of FIG. 1) according to an embodiment may include a display module 302 (e.g., the display module 160 of FIG. 1) and a processor 301 (e.g., the processor 120 of FIG. 1) that controls the display module 302. In this embodiment of the disclosure, it is assumed that a first external electronic device 303, a second external electronic device 304, and a third external electronic device 305 are located near the electronic device 205. In an embodiment of the disclosure, the user may send a data sharing command (or a data transmission command) to the electronic device 205 through the display module 302 to transmit data of the electronic device 205 to external electronic devices near the electronic device 205. For example, the user may enter the data sharing command by selecting a data sharing button on a user interface displayed on the display module 302 to transmit the data of the electronic device 205 to external electronic devices near the electronic device 205.

In operation 313, the electronic device 205 may receive the data sharing command through the display module 302. In operation 315, the data sharing command may be transferred to the processor 301 of the electronic device 205. In operation 316, upon receiving the data sharing command, the processor 301 may broadcast a search request packet using short-range wireless communication (e.g., BLE communication) to search for external electronic devices near the electronic device 205. For example, the processor 301 may broadcast the search request packet through a communication module (not shown) of the electronic device 205 (e.g., the communication module 190 of FIG. 1). The search request packet may include account information of the user of the electronic device 205. The search request packet may include identification information of the electronic device 205 and device type information of the electronic device 205.

The search request packet may include information on types of wireless connection methods supported by the electronic device 205. For example, the electronic device 205 may support at least one of wireless connection methods, such as Wi-Fi direct, Wi-Fi aware, neighborhood aware networking (NAN) communication, LAN communication, Bluetooth™ communication, or thread communication, and the search request packet may include information on the types of wireless connection methods supported by the electronic device 205. However, the wireless connection methods supported by the electronic device 205 listed above are only examples, and the electronic device 205 may support various wireless connection methods in addition to the wireless connection methods listed above.

The first external electronic device 303, the second external electronic device 304, and the third external electronic device 305 may be in a search wait state. The first external electronic device 303 may receive a search request packet in operation 307, the second external electronic device 304 may receive a search request packet in operation 309, and the third external electronic device 305 may receive a search request packet in operation 311. When receiving a search request packet, the first external electronic device 303, the second external electronic device 304, and the third external electronic device 305 may broadcast a search response packet in response to a search request in operations 317, 319, and 321.

In an embodiment of the disclosure, the search response packet may include account information and device information of an external electronic device that transmits the search response packet. The device information may include, for example, information on a type (e.g., a television (TV), a smartphone, or a personal computer (PC)) of external electronic device. The search response packet may include information on a type of wireless connection method supported by the external electronic device that transmits the search response packet. Even when the external electronic device supports a type of wireless connection method not included in the search request packet, information on the type of wireless connection method not included in the search request packet may not be included in the search response packet.

In operation 323, the processor 301 may receive the search response packets of the first external electronic device 303, the second external electronic device 304, and the third external electronic device 305. For example, the processor 301 may receive the search response packet through the communication module of the electronic device 205.

In an embodiment of the disclosure, the processor 301 may identify and distinguish external electronic devices based on the search response packet. For example, the processor 301 may classify the first external electronic device 303, the second external electronic device 304, and the third external electronic device 305 into a user device, a friend device, and other devices, based on the account information included in the search response packet. For example, the processor 301 may classify the first external electronic device 303, the second external electronic device 304, and the third external electronic device 305 by a type of device based on the device information included in the search response packet. For example, the processor 301 may classify the first external electronic device 303, the second external electronic device 304, and the third external electronic device 305 by the type of supported wireless connection method based on the type of wireless connection method included in the search response packet.

In operation 325, the processor 301 may transfer search result information to be displayed through the display module 302 to the display module 302 based on a search result. In operation 327, the display module 302 may display the search result information through the display of the display module 302. For example, the display module 302 may list found external electronic devices on the display or display external electronic devices classified based on the search response packet.

The user of the electronic device 205 may select an external electronic device to which the data of the electronic device 205 is to be transmitted from among the external electronic devices displayed on the display of the display module 302. For example, in operation 329, the display module 302 may receive a user input for selecting the first external electronic device 303. In operation 331, the display module 302 may transfer the user input for selecting the first external electronic device 303 to the processor 301. When the processor 301 receives the user input, in operation 333, the processor 301 may determine whether to transmit data based on at least one of communication connection characteristics of the first external electronic device 303, a size of data to be transmitted from the electronic device 205 to the first external electronic device 303, and account information of the first external electronic device 303. For example, in operation 333, the processor 301 may determine to perform data transmission because the first external electronic device 303 is an only selected external electronic device. In operation 335, the processor 301 may perform authentication with the first external electronic device 303 and be wirelessly connected to the first external electronic device 303 using a first wireless connection method (e.g., Wi-Fi aware) supported by the first external electronic device 303.

In an embodiment of the disclosure, the electronic device 205 and an external electronic device (e.g., the first external electronic device 303) may support a plurality of wireless connection methods. For example, the search request packet may include information on the first wireless connection method (e.g., Wi-Fi aware) and a second wireless connection method (e.g., Wi-Fi direct), and the search response packet may include same information. When the electronic device 205 and the external electronic device (e.g., the first external electronic device 303) support a plurality of wireless connection methods, the electronic device 205 may determine a wireless connection method to be used for data transmission among the plurality of wireless connection methods according to quality attributes of a wireless connection method. The quality attributes of a wireless connection method may include attributes, such as transmission speed, signal interference, and failure rate of the wireless connection method. When it is assumed that the electronic device 205 and the external electronic device (e.g., the first external electronic device 303) support two wireless connection methods of Wi-Fi aware and Wi-Fi direct and that Wi-Fi Aware has quality attributes superior to Wi-Fi direct in a current communication environment, the electronic device and the external electronic device may communicate with each other through the wireless connection method of Wi-Fi aware, which has better quality attributes.

In operation 337, the processor 301 may transmit data of the electronic device 205 to the first external electronic device 303. In operation 339, the processor 301 may transfer a data transmission status of the first external electronic device 303 to the display module 302 to display the data transmission status of the first external electronic device 303 on the display of the display module 302.

The user may additionally select the second external electronic device 304 through the display module 302 while transmitting data to the first external electronic device 303. In operation 341, the display module 302 may receive a user input for selecting the second external electronic device 304. In operation 343, the display module 302 may transfer the user input for selecting the second external electronic device 304 to the processor 301. When the processor 301 receives a user input, in operation 345, the processor 301 may determine whether to transmit data based on at least one of communication connection characteristics of the second external electronic device 304, a size of the data of the electronic device 205, and account information of the second external electronic device 304. For example, the second external electronic device 304 may be an external electronic device that uses the second wireless connection method (e.g., Wi-Fi direct), unlike the first external electronic device 303. In order to transmit data to the second external electronic device 304, the wireless connection method may need to be changed after data transmission to the first external electronic device 303 is completed. Thus, in operation 345, the processor 301 may determine to wait until the data transmission of the first external electronic device 303 is completed.

The user may additionally select the third external electronic device 305 through the display module 302 while transmitting data to the first external electronic device 303. In operation 347, the display module 302 may receive a user input for selecting the third external electronic device 305. In operation 349, the display module 302 may transmit the user input for selecting the third external electronic device 305 to the processor 301. When the processor 301 receives a user input, in operation 351, the processor 301 may determine whether to transmit data based on at least one of communication connection characteristics of the third external electronic device 305, the size of the data of the electronic device 205, and account information of the third external electronic device 305. For example, the third external electronic device 305 may be, like the first external electronic device 303, an external electronic device that uses the first wireless connection method (e.g., Wi-Fi aware). Since the first external electronic device 303 and the third external electronic device 305 use the same wireless connection method, the processor 301 may change a data transmission order of the second external electronic device 304 and the third external electronic device 305. In operation 351, a data transmission order (which may be in the order of the first external electronic device 303, the second external electronic device 304, and the third external electronic device 305) corresponding to an order in which the external electronic device is selected by user inputs of operation 329, operation 341, and operation 347 may be determined to be in the order of the first external electronic device 303, the third external electronic device 305, and the second external electronic device 304. By changing the data transmission order, a time required to switch the communication method when transmitting data to the first external electronic device 303, the second external electronic device 304, and the third external electronic device 305 may be reduced.

The first wireless connection method (e.g., Wi-Fi aware) may be a wireless connection method in which the electronic device 205 may simultaneously transmit data to two or more external electronic devices. Since both the first external electronic device 303 and the third external electronic device 305 use the first wireless connection method (e.g., Wi-Fi aware), in operation 351, the processor 301 may determine to perform data transmission to the third external electronic device 305. In operation 353, the processor 301 may perform authentication with the third external electronic device 305 and be wirelessly connected to the third external electronic device 305 using the first wireless connection method (e.g., Wi-Fi aware) supported by the third external electronic device 305.

In operation 355, the processor 301 may transmit the data of the electronic device 205 to the third external electronic device 305. In operation 357, the processor 301 may transfer a data transmission status of the third external electronic device 305 to the display module 302 to display the data transmission status of the third external electronic device 305 on the display of the display module 302.

In operation 359, the data transmission to the first external electronic device 303 may be completed. The processor 301 may terminate the data transmission to the first external electronic device 303 and disconnect the wireless connection. In operation 361, the processor 301 may transfer a data transmission completion status of the first external electronic device 303 to the display module 302. In operation 363, the data transmission to the third external electronic device 305 may be completed. The processor 301 may terminate the data transmission to the third external electronic device 305 and disconnect the wireless connection. In operation 365, the processor 301 may transfer a data transmission completion status of the third external electronic device 305 to the display module 302.

In operation 367, the processor 301 may determine whether to transmit data based on at least one of the communication connection characteristics of the second external electronic device 304, a size of data that the electronic device 205 tries to transmit to the second external electronic device 304, and the account information of the second external electronic device 304. For example, in operation 367, the processor 301 may determine to perform data transmission because the second external electronic device 304 is an only remaining external electronic device among selected external electronic devices. In operation 369, the processor 301 may perform authentication with the second external electronic device 304 and be wirelessly connected to the second external electronic device 304 using the second wireless connection method (e.g., Wi-Fi direct) supported by the second external electronic device 304.

In operation 371, the processor 301 may transmit the data of the electronic device 205 to the second external electronic device 304. In operation 373, the processor 301 may transfer a data transmission status of the second external electronic device 304 to the display module 302 to display the data transmission status of the second external electronic device 304 on the display of the display module 302.

In operation 375, the data transmission to the second external electronic device 304 may be completed. The processor 301 may terminate the data transmission to the second external electronic device 304 and disconnect the wireless connection. In operation 377, the processor 301 may transfer a data transmission completion status of the second external electronic device 304 to the display module 302.

In an embodiment of the disclosure, unlike the example of FIG. 3, the electronic device 205 may determine the data transmission order after receiving all user inputs for selecting external electronic devices to which data is to be transmitted.

For example, the electronic device 205 may receive a user input for selecting the first external electronic device 303, a user input for selecting the second external electronic device 304, and a user input for selecting the third external electronic device 305 and may determine the data transmission order, based on a wireless connection method supported by the first external electronic device 303, the second external electronic device 304, and the third external electronic device 305, so that data transmission may be preferentially performed for external electronic devices to which data may be simultaneously transmitted. For example, the first wireless connection method supported by the first external electronic device 303 and the third external electronic device 305 may be NAN communication, and the second wireless connection method supported by the second external electronic device 304 may be Wi-Fi direct. The electronic device 205 may determine an order of data transmission of the first external electronic device 303 and the third external electronic device 305 that support NAN communication capable of performing simultaneous transmission to be earlier than an order of data transmission of the second external electronic device 304. The electronic device 205 may transmit data to the first external electronic device 303, the second external electronic device 304, and the third external electronic device 305 according to the determined data transmission order.

An example of adjusting the data transmission order based on the type of wireless connection method of the external electronic devices has been described above with reference to FIG. 3. However, this is only an example, and the electronic device may adjust the data transmission order corresponding to the order in which the external electronic device is selected by the user inputs, based on at least one of communication connection characteristics of the selected external electronic devices, a size of data, and account information of the selected external electronic devices, as well as the type of wireless connection methods.

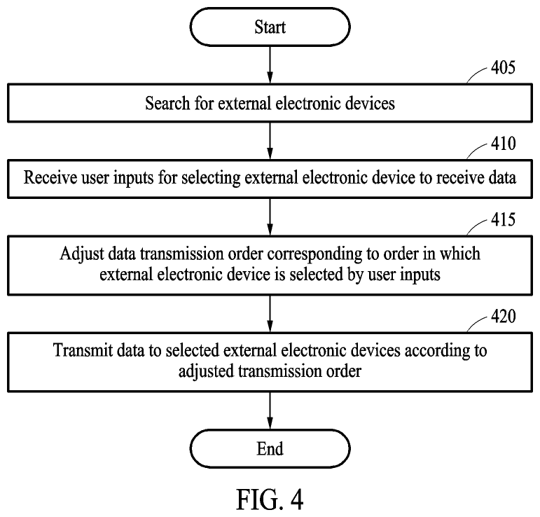

FIG. 4 is a flowchart of a method of adjusting a data transmission order according to an embodiment of the disclosure.

Referring to FIG. 4, in operation 405, the electronic device 205 (e.g., the electronic device 101 of FIG. 1) may search for external electronic devices located near the electronic device 205. For example, the electronic device 205 may search for external electronic devices located near the electronic device 205 using short-range wireless communication (e.g., BLE communication).

In operation 410, the electronic device 205 may receive user inputs for selecting an external electronic device to receive data of the electronic device 205 from among the found external electronic devices. For example, the electronic device 205 may display information related to the found external electronic devices through the display of the electronic device 205 (e.g., the display of the display module 160 of FIG. 1) and may receive user inputs, from a user, for selecting an external electronic device to receive the data of the electronic device 205 from among the found external electronic devices.

In operation 415, the electronic device 205 may adjust a data transmission order corresponding to an order in which an external electronic device is selected by the user inputs. For example, the electronic device 205 may adjust the data transmission order corresponding to the order in which the external electronic device is selected by the user inputs, based on at least one of communication connection characteristics of the selected external electronic devices, a size of the data, and account information of the selected external electronic devices.

In an embodiment of the disclosure, the communication connection characteristics may include a type of wireless connection method used for communication between the electronic device 205 and the selected external electronic devices. The electronic device 205 may adjust the data transmission order of external electronic devices, among the selected external electronic devices, which use a same wireless connection method to be in order of adjacency. When simultaneous data transmission to two or more external electronic devices may be performed depending on the type of wireless connection method, the electronic device 205 may simultaneously transmit data to the external electronic devices adjusted in order of adjacency. For example, when two or more external electronic devices form a cluster, data may be transmitted simultaneously to the external electronic devices included in a same cluster.

For example, as the example of FIG. 3, the electronic device 205 may change an order of data transmission of a third external electronic device that uses a same type of wireless connection method as a first wireless connection method, which is used for communication between the electronic device 205 and a first external electronic device currently receiving data from the electronic device 205, to be earlier than an order of data transmission of a second external electronic device that uses a second wireless connection method, which is different from the first wireless connection method.

In an embodiment of the disclosure, an operation of adjusting the data transmission order of the external electronic devices using the same wireless connection method among the selected external electronic devices to be in order of adjacency may be performed when a size of data to be transmitted to the selected external electronic devices is less than a set size. For example, when the size of the data to be transmitted to the selected external electronic devices is sufficiently large, data transmission may take a long time, so a time required to change the wireless connection method may account for a small portion of a total data transmission time. When the size of the data to be transmitted to the selected external electronic devices is greater than the set size, the operation of adjusting the data transmission order of the external electronic devices using the same wireless connection method among the selected external electronic devices to be in order of adjacency may not be performed.

In an embodiment of the disclosure, the electronic device 205 may adjust the data transmission order based on account information of the selected external electronic devices. For example, the electronic device 205 may change the data transmission order of the selected external electronic devices, based on the account information of the selected external electronic devices, to be in an order of external electronic devices of a same account as an account of the user of the electronic device 205, external electronic devices of an account of a friend of the user, and external electronic devices of other accounts. Since the electronic device 205 may adjust the data transmission order based on the account information of the selected external electronic devices, data may be preferentially transmitted to an electronic device with a high relevance to the user of the electronic device 205 and improved connectivity may be provided between electronic devices with a high relevance to the user.

In an embodiment of the disclosure, the communication connection characteristics may include at least one of a distance between the electronic device 205 and the selected external electronic devices and a signal strength.

In an embodiment of the disclosure, the electronic device 205 may change the data transmission order in an order of signal strength based on the signal strength (e.g., received signal strength indication (RSSI)) of the selected external electronic devices. The electronic device 205 may determine a distance between the electronic device 205 and the selected external electronic devices based on the signal strength. The electronic device 205 may also measure the distance to an external electronic device using an inter-device distance measurement method provided by other communication technologies (e.g., Bluetooth™ communication or Wi-Fi communication). The electronic device 205 may change the data transmission order of the selected external electronic devices in order of distance to the electronic device 205, beginning with the nearest.

In an embodiment of the disclosure, the communication connection characteristics may include a time elapsed since a last data transmission to the selected external electronic devices. The electronic device 205 may change the data transmission order of the selected external electronic devices in order of the shortest time elapsed since the last data transmission to the selected external electronic devices. By changing the data transmission order of the selected external electronic devices in order of the shortest time elapsed since the last data transmission, data may be preferentially transmitted to an external electronic device that the user frequently uses.

In an embodiment of the disclosure, the communication connection characteristics may include a frequency of data transmission to the selected external electronic devices. The electronic device 205 may change the data transmission order of the selected external electronic devices in order of high data transmission frequency.

In operation 420, the electronic device 205 may transmit data to the selected external electronic devices according to the adjusted transmission order. When simultaneous transmission of data to the adjacent external electronic devices may be performed according to the adjusted transmission order, the electronic device 205 may simultaneously transmit data to two or more external electronic devices among the selected external electronic devices.

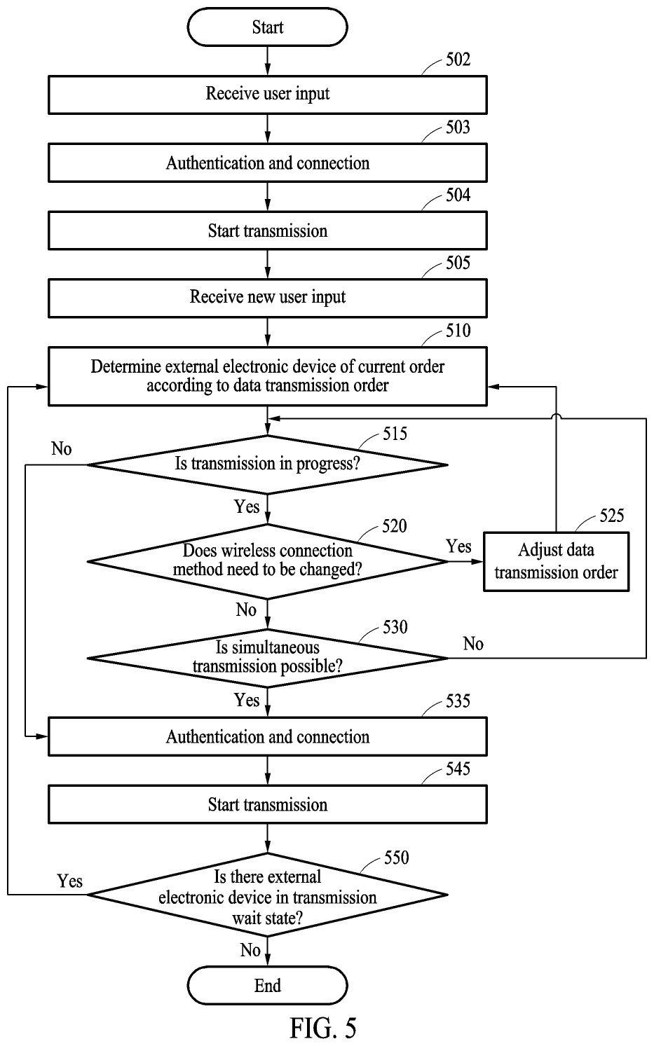

FIG. 5 is a flowchart of an electronic device changes a data transmission order of external electronic devices according to a wireless connection method according to an embodiment of the disclosure.

Referring to FIG. 5, in operation 502, the electronic device 205 may receive a user input for selecting an external electronic device to receive data of the electronic device 205 from among the found external electronic devices (e.g., the found external electronic devices in operation 405 of FIG. 4). For example, the electronic device 205 may receive a user input for selecting the first external electronic device 303 of FIG. 3. A user may select the data of the electronic device 205 to be shared with an external electronic device and subsequently select an external electronic device to share the corresponding data with, or may select an external electronic device to share data with and subsequently select the data of the electronic device 205 to be shared.

In operation 503, the electronic device 205 may perform authentication with an external electronic device (e.g., the first external electronic device 303) selected by the user input and be wirelessly connected to the selected external electronic device using a wireless connection method (e.g., Wi-Fi aware) supported by the selected external electronic device.

In operation 504, the electronic device 205 may start transmitting the data to the selected external electronic device (e.g., the first external electronic device 303).

In an embodiment of the disclosure, the electronic device 205 may continuously monitor whether a designated external electronic device exists in the vicinity of the electronic device 205, and when it is determined that a designated external electronic device exists, the electronic device 205 may automatically perform operations of authentication and connection (e.g., operations of authentication and connection in operation 503) with the designated external electronic device and transmit selected data to the designated external electronic device. The designated external electronic device may include, for example, an external electronic device determined as a trusted external electronic device by the electronic device 205 or an external electronic device that has a history of previously transmitting and receiving data to and from the electronic device 205. Starting data transmission to the designated external electronic device may be, for example, performed automatically, or performed when receiving a user input of a wireless connection permission for data transmission from the user of the electronic device 205 and/or a user of the designated external electronic device.

In operation 505, the electronic device 205 may additionally receive user inputs for selecting an external electronic device to receive the data of the electronic device 205 from among the found external electronic devices (e.g., the found external electronic devices in operation 405 of FIG. 4).

In an embodiment of the disclosure, the electronic device 205 may add the selected external electronic devices to a queue according to the order in which the external electronic devices are selected based on user inputs. For example, when the electronic device 205 additionally receives a user input for selecting the second external electronic device 304 and a user input for selecting the third external electronic device 305 of FIG. 3 sequentially, the second external electronic device 304 and the third external electronic device 305 may be sequentially added to a queue. The user input may include, for example, a user input for changing the data transmission order of the external electronic devices and/or a user input for canceling a data transmission request for one or more external electronic devices. When the user input for canceling the data transmission request is received, the electronic device 250 may delete the external electronic device that is a subject of cancelation of the data transmission request from the queue and may adjust the data transmission order based on external electronic devices remaining in the queue.

In an embodiment of the disclosure, the electronic device 205 may determine an external electronic device of a current order according to the data transmission order corresponding to the order in which the external electronic devices are selected by the user inputs of operation 505 and may adjust the data transmission order based on a wireless connection method of an external electronic device (e.g., the first external electronic device 303) to which the electronic device 205 is transmitting data and a wireless connection method supported by the external electronic device of the current order.

In an embodiment of the disclosure, the electronic device 205 may determine the data transmission order based on account information of external electronic devices selected by the user inputs of operation 505, determine the data transmission order based on at least one of a distance between the electronic device 205 and the selected external electronic devices and a signal strength, determine the data transmission order based on a time lapsed from a last data transmission to the selected external electronic devices, or determine the data transmission order based on a frequency of data transmission to the selected external electronic devices. The electronic device 205 may determine the external electronic device of the current order according to the determined data transmission order and may adjust the data transmission order based on the wireless connection method of the external electronic device (e.g., the first external electronic device 303) to which the electronic device 205 is transmitting data and the wireless connection method supported by the external electronic device of the current order.

Hereinafter, for concise description, an example is given in which the data transmission order corresponding to the order in which the external electronic devices are selected by the user inputs of operation 505.

In operation 510, the electronic device 205 may determine the external electronic device of the current order according to the data transmission order corresponding to the order in which the external electronic devices are selected by the user inputs. The electronic device 205 may determine a first external electronic device in the queue as the external electronic device of the current order. For example, when the electronic device 205 additionally receives user inputs for selecting the second external electronic device 304 and the third external electronic device 305 sequentially, the electronic device 205 may determine the second external electronic device 304 as the external electronic device of the current order. In operation 510, the external electronic device determined to be the external electronic device of the current order may be deleted from the queue.

In operation 515, the electronic device 205 may determine whether the electronic device 205 is transmitting data to another external electronic device. For example, when the external electronic device of the current order is the second external electronic device 304 and the electronic device 205 is transmitting data to the first external electronic device 303, the electronic device 205 may be determined to be transmitting data to another external electronic device.

When the electronic device 205 is transmitting data to another external electronic device, the electronic device 205 may determine, in operation 520, whether a wireless connection method needs to be switched to transmit data to the external electronic device of the current order. For example, as shown in the example of FIG. 3, when the first external electronic device 303 uses a first wireless connection method (e.g., Wi-Fi aware) and the second external electronic device 304, which is the external electronic device of the current order, uses a second wireless connection method (e.g., Wi-Fi direct), the electronic device 205 may determine that the wireless connection method needs to be switched.

When it is determined that the wireless connection method needs to be switched, the electronic device 205 may adjust the data transmission order in operation 525. For example, the electronic device 205 may adjust an order of data transmission of the external electronic device of the current order to be later than the external electronic device of a next order and add the external electronic device of the current order to the queue. For example, referring to the example of FIG. 3, the electronic device 205 may adjust the order of data transmission of the second external electronic device 304, which is the external electronic device of the current order, to a later order than an order of data transmission of the third external electronic device 305, which is the external electronic device of the next order. For example, the electronic device 205 may add the external electronic device of the current order to a second order in the queue. In this case, the external electronic device in the first order in the queue may be the third external electronic device 305.

When the wireless connection method with the external electronic device to which the electronic device 205 is transmitting data is the same as the wireless connection method with the external electronic device of the current order, it may be determined in operation 520 that the wireless connection method does not need to be switched. When it is determined that the wireless connection method does not need to be switched, the electronic device 205 may determine, in operation 530, whether data may be transmitted simultaneously to the external electronic device to which the electronic device 205 is transmitting data and the external electronic device of the current order. A possibility of simultaneous transmission may be determined depending on the type of wireless connection method. For example, when the wireless connection method of the external electronic device (e.g., the first external electronic device 303) to which the electronic device 205 is transmitting data and the wireless connection method of the external electronic device (e.g., the third external electronic device 305) of the current order are both Wi-Fi aware, simultaneous transmission of data may be possible. However, this is only an example, and simultaneous transmission of data may be performed using various wireless connection methods. Simultaneous transmission of data may use communication technologies for 1-to-N (here, N may be a natural number of 2 or more) transmission, and even different communication technologies may be used for simultaneous transmission of data provided that the different communication technologies may be used in combination with each other. For example, while a wireless connection is established using the Wi-Fi aware method and data is being transmitted, data transmission through other communication technologies, such as LAN, Bluetooth™, or Wi-Fi station (STA) may be possible.

When it is determined in operation 530 that simultaneous transmission of data is possible, the electronic device 205 may perform operations 535, 545, and 550 and accordingly, may additionally transmit data to the external electronic device (e.g., the third external electronic device 305) of the current order along with the external electronic device (e.g., the first external electronic device 303) to which the electronic device 205 is transmitting data. For example, in operation 535, the electronic device 205 may perform authentication with the external electronic device (e.g., the third external electronic device 305) of the current order and may be wirelessly connected to the external electronic device (e.g., the third external electronic device 305) of the current order using the wireless connection method used by the external electronic device (e.g., the first external electronic device 303), to which the electronic device 205 is transmitting data, to receive data. In operation 545, the electronic device 205 may additionally transmit data to the external electronic device (e.g., the third external electronic device 305) of the current order along with the external electronic device (e.g., the first external electronic device 303) to which data is being transmitted.

When it is determined in operation 530 that simultaneous transmission of data is not possible, the electronic device 205 may determine, in operation 515, whether the electronic device 205 is transmitting data to another external electronic device. When the electronic device 205 is not transmitting data to another external electronic device, the electronic device 205 may perform operation 535. For example, since simultaneous transmission of data is not possible, the electronic device 205 may transmit data by performing operations 535 and 545 on the external electronic device (e.g., the third external electronic device 305) of the current order after the data transmission to the external electronic device (e.g., the first external electronic device 303) to which the electronic device 205 is transmitting data is completed.

In an embodiment of the disclosure, the electronic device 205 may determine whether transmission to an external electronic device is possible based on the data transmission order. The electronic device 205 may determine a connection status with the external electronic device of the current order and, when it is determined that the connection with the external electronic device of the current order is terminated (e.g., when the connection status is not confirmed for a determined period of time), for example, due to movement of the external electronic device of the current order or deterioration in communication quality, may perform an authentication and connection process (e.g., an authentication and connection process in operation 535) with the external electronic device of the next order. Alternatively, when continuous transmission failure occurs more than a determined number of times with respect to the external electronic device of the current order, the electronic device 205 may determine that the connection with the external electronic device is terminated and may perform the authentication and connection process (e.g., an authentication and connection process in operation 535) with the external electronic device of the next order.

In operation 550, the electronic device 205 may determine whether a selected external electronic device in a transmission wait state exists, based on the data transmission order. For example, the electronic device 205 may determine whether an external electronic device is remaining in the queue. When an external electronic device is remaining in the queue, the electronic device 205 may determine that a selected external electronic device in a transmission wait state exists. When no external electronic device is remaining in the queue, the electronic device 205 may determine that no selected external electronic device in a transmission wait state exists. For example, in the example of FIG. 3, when the electronic device 205 is simultaneously transmitting data to the first external electronic device 303 and the third external electronic device 305, the second external electronic device 304 may be in the first order in the queue. In this case, the electronic device 205 may determine that an external electronic device is remaining in the queue.

When an external electronic device in a transmission wait state exists, in operation 510, the electronic device 205 may determine the external electronic device of the next order as the external electronic device of the current order based on the data transmission order. For example, in the example of FIG. 3, when the electronic device 205 is simultaneously transmitting data to the first external electronic device 303 and the third external electronic device 305, the electronic device 205 may determine the first external electronic device (e.g., the second external electronic device 304) in the queue as the external electronic device of the current order. When data transmission to both the first external electronic device 303 and the third external electronic device 305 is completed, in operation 515, the electronic device 205 may determine that data transmission is not in progress. When it is determined in operation 515 that data transmission is not in progress, the electronic device 205 may perform authentication with the second external electronic device 304 and be wirelessly connected to the second external electronic device 304 using the wireless connection method (e.g., Wi-Fi direct) supported by the second external electronic device 304 in operation 535. The electronic device 205 may start transmitting data to the second external electronic device 304 in operation 545. In operation 550, the electronic device 205 may determine that no selected external electronic device in a transmission wait state exists since no external electronic device is remaining in the queue. The electronic device 205 may complete data transmission to the external electronic devices and terminate the wireless connection.

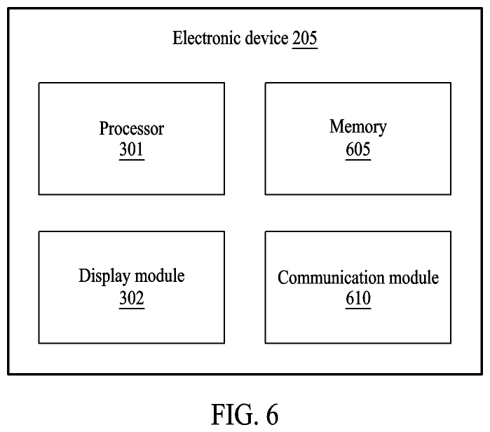

FIG. 6 is a block diagram illustrating an electronic device according to an embodiment of the disclosure.

Referring to FIG. 6, in an embodiment of the disclosure, the electronic device 205 (e.g., the electronic device 101 of FIG. 1) may include the processor 301 (e.g., the processor 120 of FIG. 1), memory 605 (e.g., the memory 130 in FIG. 1) configured to store instructions to be executed by the processor 301, a display module 302 (e.g., the display module 160 of FIG. 1), and a communication module 610 (e.g., the communication module 190 of FIG. 1). When the instructions are executed by the processor 301, the processor 301 may perform an operation of searching for external electronic devices located near the electronic device 205, an operation of receiving user inputs for selecting an external electronic device to receive data of the electronic device 205, an operation of adjusting the data transmission order corresponding to the order in which the external electronic device is selected by the user inputs, based on at least one of communication connection characteristics of the selected external electronic devices, a size of data, and account information of the selected external electronic devices, and an operation of transmitting the data to the selected external electronic devices according to the adjusted data transmission order.

The processor 301 may search for an external electronic device using the communication module 610 and transmit data to the external electronic device. The display module 302 may include a display.

The communication connection characteristics may include a type of wireless connection method used for communication between the electronic device 205 and the selected external electronic devices. The operation of adjusting the data transmission order may include an operation of adjusting the data transmission order of the external electronic devices using a same wireless connection method among the selected external electronic devices to be in order of adjacency.

The operation of adjusting to the order of adjacency may include an operation of changing an order of data transmission of a third external electronic device that uses a same type of wireless connection method as a first wireless connection method, which is used for communication between the electronic device 205 and a first external electronic device currently receiving data from the electronic device 205, to be earlier than an order of data transmission of a second external electronic device that uses a second wireless connection method, which is different from the first wireless connection method.

The operation of adjusting the data transmission order may be performed when a size of data to be transmitted to the selected external electronic devices is less than a set size.

The operation of adjusting the data transmission order may include an operation of changing the data transmission order of the selected external electronic devices, based on the account information, to be in an order of external electronic devices of a same account as an account of the user of the electronic device 205, external electronic devices of an account of a friend of the user, and external electronic devices of other accounts.

The communication connection characteristics may include a distance between the electronic device 205 and the selected external electronic devices, and the operation of adjusting the data transmission order may include an operation of changing the data transmission order of the selected external electronic devices to be in order of the distance.

The communication connection characteristics may include a time elapsed since a last data transmission to the selected external electronic devices, and the operation of adjusting the data transmission order may include an operation of changing the data transmission order of the selected external electronic devices in order of the elapsed time.

The communication connection characteristics may include a frequency of data transmission to the selected external electronic devices, and the operation of adjusting the data transmission order may include an operation of changing the data transmission order of the selected external electronic devices in order of high data transmission frequency.

The processor 301 may further perform an operation of displaying found external electronic devices through the display so that the user may select an external electronic device and an operation of displaying a communication status between the electronic device 205 and the selected external electronic devices through the display.

The processor 301 may further perform an operation of displaying the adjusted data transmission order of the selected external electronic devices through the display.

A method of adjusting the data transmission order of the external electronic devices that receive data from the electronic device 205 according to an embodiment may include the operation of searching for external electronic devices located near the electronic device 205, the operation of receiving user inputs for selecting an external electronic device to receive data of the electronic device 205, the operation of adjusting the data transmission order corresponding to the order in which the external electronic device is selected by the user inputs, based on at least one of communication connection characteristics of the selected external electronic devices, a size of data, and account information of the selected external electronic devices, and the operation of transmitting the data to the selected external electronic devices according to the adjusted data transmission order.

The communication connection characteristics may include a type of wireless connection method used for communication between the electronic device 205 and the selected external electronic devices. The operation of adjusting the data transmission order may include an operation of adjusting the data transmission order of the external electronic devices using a same wireless connection method among the selected external electronic devices to be in order of adjacency.

The operation of adjusting to the order of adjacency may include an operation of changing an order of data transmission of the third external electronic device that uses a same type of wireless connection method as the first wireless connection method, which is used for communication between the electronic device 205 and the first external electronic device currently receiving data from the electronic device 205, to be earlier than an order of data transmission of the second external electronic device that uses the second wireless connection method, which is different from the first wireless connection method.

The operation of adjusting the data transmission order may be performed when the size of the data to be transmitted to the selected external electronic devices is less than the set size.

The operation of adjusting the data transmission order may include an operation of changing the data transmission order of the selected external electronic devices, based on the account information, to be in an order of external electronic devices of a same account as an account of the user of the electronic device 205, external electronic devices of an account of a friend of the user, and external electronic devices of other accounts.

The communication connection characteristics may include the distance between the electronic device 205 and the selected external electronic devices, and the operation of adjusting the data transmission order may include an operation of changing the data transmission order of the selected external electronic devices to be in order of the distance.

The communication connection characteristics may include the time elapsed since the last data transmission to the selected external electronic devices, and the operation of adjusting the data transmission order may include an operation of changing the data transmission order of the selected external electronic devices in order of the elapsed time.

The communication connection characteristics may include the frequency of data transmission to the selected external electronic devices, and the operation of adjusting the data transmission order may include an operation of changing the data transmission order of the selected external electronic devices in order of high data transmission frequency.

An operation of displaying the found external electronic devices through the display of the electronic device 205 so that the user may select an external electronic device, an operation of displaying a communication status between the electronic device 205 and the selected external electronic devices through the display, and displaying the adjusted data transmission order of the selected external electronic devices through the display may be further included.

The electronic device according to various embodiments disclosed herein may be one of various types of electronic devices. The electronic device may include, for example, a portable communication device (e.g., a smartphone), a computer device, a portable multimedia device, a portable medical device, a camera, a wearable device, or a home appliance device. According to an embodiment of the disclosure, the electronic device is not limited to the devices described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related components. It is to be understood that a singular form of a noun corresponding to an item may include one or more of the things, unless the relevant context clearly indicates otherwise. As used herein, “A or B,” “at least one of A and B,” “at least one of A or B,” “A, B or C,” “at least one of A, B and C,” and “at least one of A, B, or C,” may include any one of the items listed together in the corresponding one of the phrases, or all possible combinations thereof. Terms, such as “1st” and “2nd,” or “first” and “second” may be used to simply distinguish a corresponding component from other components, and do not limit the components in other aspects (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with embodiments of the disclosure, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or more functions. For example, according to an embodiment of the disclosure, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment of the disclosure, a method according to various embodiments of the disclosure may be included and provided in a computer program product. The computer program product may be traded as a product between a seller and a buyer. The computer program product may be distributed in the form of a machine-readable storage medium (e.g., compact disc read-only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to embodiments of the disclosure, each component (e.g., a module or a program) of the above-described components may include a single entity or multiple entities, and some of the multiple entities may be separately disposed in different components. According to embodiments of the disclosure, one or more of the above-described components may be omitted, or one or more other components may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to embodiments of the disclosure, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
memory storing one or more computer programs; and
one or more processors communicatively coupled to the memory,
wherein the one or more computer programs include computer-executable instructions that, when executed by the one or more processors individually or collectively, cause the electronic device to:
search for external electronic devices located near the electronic device,
receive user inputs for selecting external electronic devices to which data of the electronic device is to be transmitted from among found external electronic devices,
adjust a data transmission order corresponding to an order in which the selected external electronic devices are selected by the user inputs, based on at least one of communication connection characteristics of the selected external electronic devices, a size of the data, or account information of the selected external electronic devices, and
transmit the data to the selected external electronic devices according to the adjusted data transmission order.

2. The electronic device of claim 1,
wherein the communication connection characteristics comprise:
a type of wireless connection method used for communication between the electronic device and the selected external electronic devices, and
wherein the one or more computer programs further include computer-executable instructions that, when executed by the one or more processors individually or collectively, cause the electronic device to:
adjust the data transmission order of external electronic devices using a same wireless connection method among the selected external electronic devices to be in order of adjacency.

3. The electronic device of claim 2, wherein the one or more computer programs further include computer-executable instructions that, when executed by the one or more processors individually or collectively, cause the electronic device to:
change a data transmission order of a third external electronic device that uses a same type of wireless connection method as a first wireless connection method, which is used for communication between the electronic device and a first external electronic device currently receiving data from the electronic device, to be earlier than a data transmission order of a second external electronic device that uses a second wireless connection method, which is different from the first wireless connection method.

4. The electronic device of claim 2, wherein the adjusting of the data transmission order is performed when a size of data to be transmitted to the selected external electronic devices is less than a set size.

5. The electronic device of claim 1, wherein the one or more computer programs further include computer-executable instructions that, when executed by the one or more processors individually or collectively, cause the electronic device to:
change the data transmission order of the selected external electronic devices, based on the account information, to be in an order of external electronic devices of a same account as an account of the user of the electronic device, external electronic devices of an account of a friend of the user, and external electronic devices of other accounts.

6. The electronic device of claim 1,
wherein the communication connection characteristics comprise:
a distance between the electronic device and the selected external electronic devices, and
wherein the one or more computer programs further include computer-executable instructions that, when executed by the one or more processors individually or collectively, cause the electronic device to:
change the data transmission order of the selected external electronic devices to be in order of the distance.

7. The electronic device of claim 1,
wherein the communication connection characteristics comprise:
a time elapsed since a last data transmission to the selected external electronic devices, and
wherein the one or more computer programs further include computer-executable instructions that, when executed by the one or more processors individually or collectively, cause the electronic device to:
change the data transmission order of the selected external electronic devices in order of the elapsed time.

8. The electronic device of claim 1,
wherein the communication connection characteristics comprise:
a frequency of data transmission to the selected external electronic devices, and
wherein the one or more computer programs further include computer-executable instructions that, when executed by the one or more processors individually or collectively, cause the electronic device to:
change the data transmission order of the selected external electronic devices in order of high data transmission frequency.

9. The electronic device of claim 1,
wherein the electronic device further comprises:
a display module, and
wherein the one or more computer programs further include computer-executable instructions that, when executed by the one or more processors individually or collectively, cause the electronic device to:
display the found external electronic devices through the display module so that the user selects an external electronic device, and
display a communication status between the electronic device and the selected external electronic devices through the display module.

10. The electronic device of claim 9, wherein the one or more computer programs further include computer-executable instructions that, when executed by the one or more processors individually or collectively, cause the electronic device to:
display the adjusted data transmission order of the selected external electronic devices through the display module.

11. A method of adjusting a data transmission order from an electronic device to external electronic devices, the method comprising:
searching for external electronic devices located near the electronic device;
receiving user inputs for selecting an external electronic device to which data of the electronic device is to be transmitted from among found external electronic devices;
adjusting a data transmission order corresponding to an order in which the selected external electronic devices are selected by the user inputs, based on at least one of communication connection characteristics of the selected external electronic devices, a size of the data, or account information of the selected external electronic devices; and
transmitting the data to the selected external electronic devices according to the adjusted data transmission order.

12. The method of claim 11,
wherein the communication connection characteristics comprise:
a type of wireless connection method used for communication between the electronic device and the selected external electronic devices, and wherein the adjusting of the data transmission order comprises:
adjusting the data transmission order of external electronic devices using a same wireless connection method among the selected external electronic devices to be in order of adjacency.

13. The method of claim 12, wherein the adjusting of the data transmission order comprises:
changing a data transmission order of a third external electronic device that uses a same type of wireless connection method as a first wireless connection method, which is used for communication between the electronic device and a first external electronic device currently receiving data from the electronic device, to be earlier than a data transmission order of a second external electronic device that uses a second wireless connection method, which is different from the first wireless connection method.

14. The method of claim 11, wherein the adjusting of the data transmission order comprises:
changing the data transmission order of the selected external electronic devices, based on the account information, to be in an order of external electronic devices of a same account as an account of the user of the electronic device, external electronic devices of an account of a friend of the user, and external electronic devices of other accounts.

15. The method of claim 12, wherein the adjusting of the data transmission order is performed when a size of data to be transmitted to the selected external electronic devices is less than a set size.

16. The method of claim 11,
wherein the communication connection characteristics comprise:
a distance between the electronic device and the selected external electronic devices, and
wherein the adjusting of the data transmission order comprises:
changing the data transmission order of the selected external electronic devices to be in order of the distance.

17. The method of claim 11,
wherein the communication connection characteristics comprise:
a time elapsed since a last data transmission to the selected external electronic devices, and
wherein the adjusting of the data transmission order comprises:
changing the data transmission order of the selected external electronic devices in order of the elapsed time.

18. The method of claim 11,
wherein the communication connection characteristics comprise:
a frequency of data transmission to the selected external electronic devices, and
wherein the adjusting of the data transmission order comprises:
changing the data transmission order of the selected external electronic devices in order of high data transmission frequency.

19. One or more non-transitory computer-readable storage media storing computer-executable instructions that, when executed by one or more processors individually or collectively, cause an electronic device to perform operations of adjusting a data transmission order from the electronic device to external electronic devices, the operations comprising:
searching for external electronic devices located near the electronic device;
receiving user inputs for selecting an external electronic device to which data of the electronic device is to be transmitted from among found external electronic devices;
adjusting a data transmission order corresponding to an order in which the selected external electronic devices are selected by the user inputs, based on at least one of communication connection characteristics of the selected external electronic devices, a size of the data, or account information of the selected external electronic devices; and
transmitting the data to the selected external electronic devices according to the adjusted data transmission order.

20. The one or more non-transitory computer-readable storage media of claim 19,
wherein the communication connection characteristics comprise:
a type of wireless connection method used for communication between the electronic device and the selected external electronic devices, and
wherein the adjusting of the data transmission order comprises:
adjusting the data transmission order of external electronic devices using a same wireless connection method among the selected external electronic devices to be in order of adjacency.
